(19) United States
(12) Patent Application Publication
(10) Pub. No.: US 2025/0273231 A1
(43) Pub. Date: Aug. 28, 2025

(54) PERSONALIZING A SPEECH ENHANCEMENT NEURAL NETWORK USING SAMPLES OF A TARGET SPEAKER'S CLONED VOICE

(71) Applicant: Chromatic Inc., New York, NY (US)

(72) Inventors: Igor Lovchinsky, New York, NY (US); Nicholas Morris, Brooklyn, NY (US)

(21) Appl. No.: 19/065,431

(22) Filed: Feb. 27, 2025

Related U.S. Application Data
(60) Provisional application No. 63/558,821, filed on Feb. 28, 2024.

(51) Int. Cl. G10L 25/30; G10L 21/007

(52) U.S. Cl. CPC G10L 25/30; G10L 21/007

(57) ABSTRACT

A system for training a speech enhancement neural network personalized for a target speaker's voice may include an ear-worn device configured to run the speech enhancement neural network, a processing device in communication with an ear-worn device, and one or more servers in communication with the processing device. The one or more servers may be configured to receive one or more recordings of the target speaker's voice; generate, using a voice cloning neural network and the one or more recordings of the target speaker's voice, one or more samples of the target speaker's cloned voice; and generate, using the one or more samples of the target speaker's cloned voice, one or more personalized parameters for the speech enhancement neural network. The processing device may be configured to transmit the one or more personalized parameters for the speech enhancement neural network to the ear-worn device.

### BACKGROUND

The present disclosure relates to speech enhancement neural networks. In particular, the present disclosure relates to personalizing a speech enhancement neural network using samples of a target speaker's cloned voice.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

### DETAILED DESCRIPTION

Recently, speech enhancement neural networks have been developed. For example, speech enhancement neural networks may be trained to reduce noise in audio. Such neural networks may have applications, for example, in ear-worn devices, such as hearing aids, cochlear implants, and earphones. Further description of such neural networks may be found in U.S. Pat. No. 11,812,225, titled METHOD, APPARATUS AND SYSTEM FOR NEURAL NETWORK HEARING AID, and issued on Nov. 7, 2023, which is incorporated by reference herein in its entirety.

The inventors have recognized that neural networks may perform better when they are personalized with data that is similar to the kinds of inputs the neural network will receive when operating in the real world. Thus, the inventors have recognized that for a speech enhancement neural network that will run on an ear-worn device, personalizing the speech enhancement neural network using voices of people with whom the ear-worn device wearer normally interacts (referred to herein as target speakers) may enable the neural network to perform better speech enhancement. In some embodiments, personalizing a speech enhancement neural network for a target speaker's voice may include training the speech enhancement neural network using training data for the target speaker's voice. However, the inventors have recognized that generating a sufficient amount of training data for a target speaker's voice can be difficult, as it may require capturing a large body of audio samples of the target speaker's voice (where a larger body may include a large number of audio samples, audio samples of long length, or both). The inventors have recognized that voice cloning can be used to generate a large body of audio samples of the target speaker's cloned voice based on a much smaller body of recordings of the target speaker's actual voice. The smaller body of recordings of the target speaker's actual voice may be, for example, a recording on the order of seconds or minutes (e.g., 10 seconds-2 minutes), and may be easily captured with the ear-worn device or a processing device such as a smartphone, tablet, or computer. In some embodiments, personalizing a speech enhancement neural network for a target speaker's voice may include inputting an embedding (which may be thought of as a signature, a representation, and/or a parameterization) of the target speaker's voice to the speech enhancement neural network. However, the inventors have recognized that generating a high-quality embedding of a target speaker's voice can be difficult, as it may require capturing a sufficiently high-quality audio sample of the target speaker's voice. The inventors have recognized that voice cloning can be used to generate a high-quality audio sample of the target speaker's cloned voice based on a lower-quality recording of the target speaker's actual voice. In some embodiments, the quality may be related to a level of background noise, and/or a signal-to-noise ratio (SNR)).

Voice cloning may refer to using a voice cloning neural network that is trained to generate audio samples that sound like they were spoken by a target speaker, but which were not spoken by the target speaker. The voice cloning neural network may be trained to extract parameters of the target speaker's voice based on one or more recordings of the target speaker's voice. The voice cloning neural network may be further configured to receive a text corpus and use the text corpus in combination with the extracted parameters of the target speaker's voice to generate a large body of samples of the target speaker's cloned voice. The larger body of samples of the target speaker's cloned voice may be audio samples that sound like the target speaker speaking the text in the text corpus. Voice cloning technology has advanced such that audio samples of a target speaker's cloned voice may be indistinguishable (to a human and/or to a neural network) from audio samples of the target speaker's actual voice. The audio sample(s) of the target speaker's cloned voice may be used to personalize a speech enhancement neural network for the target speaker's voice. Thus, when the speech enhancement neural network runs on an ear-worn device and receives inputs containing the target speaker's actual voice, the neural network may perform better speech enhancement (e.g., better denoising). In particular, the neural network may be better able to separate the target speaker's voice in noisy environments with less distortion than a baseline neural network trained on a wide variety of voices can. Further description of voice cloning neural networks may be found, for example in Walczyna, Tomasz, and Zbigniew Piotrowski, “Overview of Voice Conversion Methods Based on Deep Learning,” Applied Sciences 13.5 (2023): 3100, the content of which is incorporated by reference herein in its entirety.

The aspects and embodiments described above, as well as additional aspects and embodiments, are described further below. These aspects and/or embodiments may be used individually, all together, or in any combination of two or more, as the disclosure is not limited in this respect.

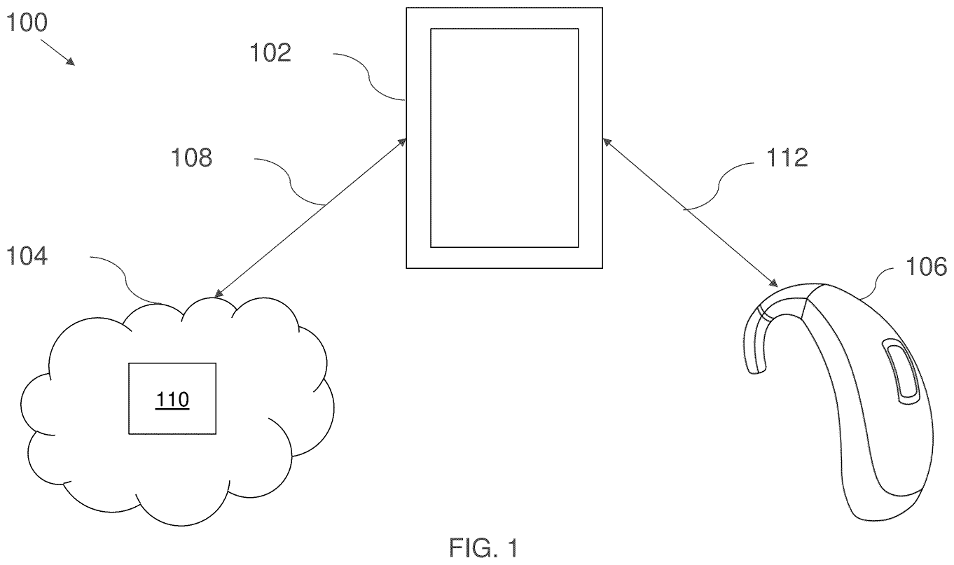

FIG. 1 illustrates a system 100, in accordance with certain embodiments described herein. The system 100 includes a processing device 102, one or more servers 104, and an ear-worn device 106. The processing device 102 may be a personal processing device, such as a smartphone, tablet, or computer. The one or more servers 104 may be considered the “cloud.” One or more neural networks 110 may be stored on the one or more servers 104. The one or more neural networks 110 may include, for example, a voice cloning neural network. Storing a neural network may include storing neural network weights. The ear-worn device 106 may be, for example, a hearing aid, a cochlear implant, or an earphone, and may be configured to run a speech enhancement neural network. The processing device 102 may be configured to communicate with the one or more servers 104 over a wireless connection 108 (e.g., a Wi-Fi connection). The processing device 102 may be configured to communicate with the ear-worn device over a wireless or wired connection 112 (e.g., a Bluetooth or NFMI connection).

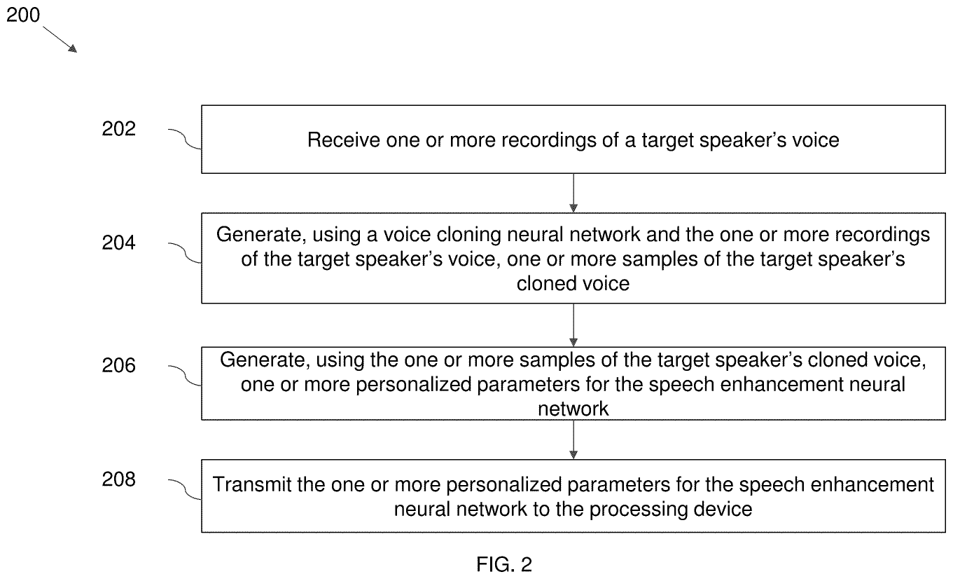

FIG. 2 illustrates a process 200 for personalizing a speech enhancement neural network for a target speaker's voice, in accordance with certain embodiments described herein. The process 200 is performed by one or more servers (e.g., the one or more servers 104), which may be considered the “cloud.” The one or more servers may store a voice cloning neural network (e.g., one of the one or more neural networks 110), in some embodiments in addition to other neural networks as described further below. Storing a neural network may include storing neural network weights. As referred to herein, storing a neural network may include storing weights for the neural network for any amount of time at any time. For example, the neural network weights for the voice cloning neural network may be stored indefinitely, and may be stored on the one or more servers when the process 200 begins. As another example, in embodiments in which the one or more servers train a speech enhancement neural network, neural network weights for the speech enhancement neural network may be stored for a short amount of time on the one or more servers before being transmitted to the processing device (e.g., at step 208), and then removed from the one or more servers. Furthermore, the neural network weights for the speech enhancement neural network may not necessarily be stored on the one or more servers when the process 200 begins.

At step 202, the one or more servers receive one or more recordings of a target speaker's voice. For example, the target speaker may be a family member, a friend, or a colleague of the wearer of the ear-worn device. In some embodiments, the one or more recordings of the target speaker's voice may be transmitted from a processing device (e.g., a smartphone, tablet, or laptop). In some embodiments, the processing device may be in communication with an ear-worn device (e.g., the processing device 102 in communication with the ear-worn device 106). The processing device may be considered in communication with the ear-worn device even if the processing device is not in communication with the ear-worn device for the entirety or any of the process 200. In some embodiments, the processing device may be a second processing device not in communication with the ear-worn device. For example, it may be the processing device of the target speaker. In some embodiments, the one or more servers may be configured to receive just one recording of the target speaker's voice. In some embodiments, the length of the recording may be equal to 10 seconds, equal to 2 minutes, or between 10 seconds and 2 minutes. In some embodiments, the one or more servers may be configured to receive multiple recordings of the target speaker's voice. The one or more recordings received at step 202 may be the one or more recordings transmitted by the processing device at step 306 of the process 300.

In some embodiments, the one or more recordings of the target speaker's voice may be received synchronously. In other words, the one or more recordings may be received by the one or more servers at or at approximately the same time as when the conversation between the target speaker and the wearer of the ear-worn device (i.e., the conversation to be processed with the personalized speech enhancement neural network) is occurring or about to occur. In such cases, the target speaker and the wearer may be in the same place. For example, before the wearer and the target speaker begin their conversation, they may capture the one or more recordings. Or, they may stop their conversation to capture the one or more recordings. Such scenarios may be more practical when an embedding is generated based on the recordings (as described below), rather than when a neural network is trained based on the recordings (as described below), as the latter may require too much time. In some embodiments, the one or more recordings of the target speaker's voice may be received asynchronously. In other words, the one or more recordings may be received by the one or more servers before the conversation between the target speaker and the wearer of the ear-worn device occurs.

Following is a description of how the one or more recordings of the target speaker's voice may be obtained. In some embodiments (e.g., in synchronous cases), the one or more recordings of the target speaker's voice may be obtained using the microphone or microphones of the ear-worn device (e.g., the ear-worn device 106). In such embodiments, the sound signal of the target speaker's voice may be received by the microphone or microphones of the ear-worn device and be converted into an audio signal, and may optionally undergo processing by circuitry in the ear-worn device. The ear-worn device may then transmit the audio signal over a wireless connection (e.g., the wireless connection 112) to the processing device (e.g., the process device 102) in communication with the ear-worn device. The processing device may then transmit the one or more recordings of the target speaker's voice to the one or more servers (e.g., the one or more servers 104) at step 202 over a wireless connection (e.g., the wireless connection 108).

In some embodiments (e.g., in synchronous or asynchronous cases), the one or more recordings of the target speaker's voice may be obtained using the microphone or microphones of a processing device (e.g., a smartphone, tablet, or laptop). In such embodiments, the sound signal of the target speaker's voice may be received by the microphone or microphones of the processing device and be converted into an audio signal, and may optionally undergo processing by circuitry in the processing device. The processing device may then transmit the one or more recordings of the target speaker's voice to the one or more servers at step 202 over a wireless connection. In some embodiments, the processing device may be in communication with an ear-worn device (e.g., the processing device 102 in communication with the ear-worn device 106). The processing device may be considered in communication with the ear-worn device even if the processing device is not in communication with the ear-worn device for the entirety or any of the process 200. In some embodiments, the processing device may be a second processing device not in communication with the ear-worn device. For example, it may be the processing device of the target speaker.

In some embodiments, a processing device (e.g., the processing device 102 or a different processing device) may provide an instruction to capture or select the one or more recordings of a target speaker's voice. In some embodiments (e.g., in synchronous cases), the processing device may provide an instruction to capture the one or more recordings using the ear-worn device's microphone or microphones. In some embodiments (e.g., in synchronous or asynchronous cases), the processing device may provide an instruction to capture the one or more recordings using the processing device's microphone or microphones. In some embodiments, the processing device may provide the instruction as text displayed on the processing device's display screen. In some embodiments, the processing device may provide the instruction as audio outputted by the processing device's speaker. In some embodiments, the processing device may stream the instruction as audio to the ear-worn device to be outputted by the ear-worn device. As an example, the instruction may be “Start recording the speaker's voice for at least 1 minute,” or something of similar meaning. In some embodiments (e.g., in asynchronous cases), the target speaker may receive an email or text with a link on their processing device. In response to a user selection of the link, the processing device may provide the instruction. In some embodiments (e.g., in synchronous or asynchronous cases), the wearer may receive an email or text with a link on their processing device. In response to a user selection of the link, the processing device may provide the instruction. In some embodiments, the processing device may provide an option for a user to select and upload one or more already-captured recordings. For example, the processing device may provide an option for the user to upload a video or audio file that is already saved in the processing device or on one or more servers accessible by the processing device, and which includes the target speaker's voice (i.e., in which the target speaker is speaking).

In some embodiments, the processing device may instruct the user to capture a recording of a certain minimum length of time. The minimum length of time may be, for example, on the order of seconds or minutes, such as a length of time equal to 10 seconds, equal to 2 minutes, or between 10 seconds and 2 minutes. In some embodiments, the processing device may be configured to instruct the user to capture just one recording of the target speaker's voice. In some embodiments, the length of the recording may be between or equal to 10 seconds, equal to 2 minutes, or between 10 seconds and 2 minutes. In some embodiments, the processing device may instruct the user to capture more than one recording of the target speaker's voice. In such embodiments, the processing device may instruct the user to capture recordings with different characteristics. For example, the processing device may instruct the target speaker to read a speech passage that covers a wide range of phonetic components, speak at different volumes, speak at different positions relative to the processing device, speak when there are different levels of background noise, etc. In some embodiments, the user may be the wearer of an ear-worn device (e.g., the ear-worn device 106) on which the speech enhancement neural network will run. In some embodiments, the user may be the target speaker. In some embodiments, the user may be a third party.

In some embodiments, the one or more recordings of the target speaker's voice may be captured automatically. In such embodiments, the ear-worn device may be configured to automatically capture sound recordings periodically. The processing device in communication with the ear-worn device (e.g., the processing device 102) may transmit (e.g., over the wireless connection 112) commands to the ear-worn device to cause the ear-worn device to capture these sound recordings. The ear-worn device may be configured to transmit the sound recordings to the processing device (e.g., over the wireless connection 112), and the processing device may be configured to upload the sound recordings to one or more servers (which may be the same or different from the one or more servers 104). The one or more servers may be configured to run a speaker embedding neural network (which may be different from the voice cloning and speech enhancement neural networks). This neural network may be trained to determine and/or compare embeddings (which may also be referred to as voice signatures, representations, parameterizations, etc.) in the sound recordings. The neural network may be used to determine whether there is a commonly-occurring speaker in the sound recordings (i.e., a speaker voice signature that occurs in more than a threshold percentage of recordings). Then, the neural network may be used to determine if a specific sound recording contains the commonly-occurring speaker's voice speaking in quiet. If so, the processing device may be configured to save that sound recording. A group of such saved recordings may be the one or more recordings of the target speaker's voice received at step 202. Further description of speaker embedding neural networks may be found in U.S. Pat. No. 11,818,523, titled “System and method for enhancing speech of target speaker from audio signal in an ear-worn device using voice signatures,” and issued on Nov. 14, 2023, the contents of which are incorporated by reference herein in its entirety.

At step 204, the one or more servers generate, using the voice cloning neural network and the one or more recordings of the target speaker's voice, one or more samples of the target speaker's cloned voice. For example, when the samples are to be used for training a neural network, the one or more samples may include an hour or hours of samples of the target speaker's cloned voice (e.g., 1 hour, 4 hours, or between 1 and 4 hours). As another example, when the samples are to be used for generating an embedding, the one or more samples may include seconds or minutes of samples of the target speaker's cloned voice (e.g., between 5 seconds and 10 minutes, or no more than 10 minutes, or no more than 5 minutes, or no more than 2 minutes). As described above, a voice cloning neural network may be trained to generate audio samples that sound like they were spoken by a target speaker, but which were not spoken by the target speaker. The voice cloning neural network may be trained to extract parameters of the target speaker's voice based on the one or more recordings of the target speaker's voice. The voice cloning neural network may be further configured to use a text corpus (e.g., Wikipedia) in combination with the extracted parameters of the target speaker's voice to generate the one or more samples of the target speaker's cloned voice. The one or more samples of the target speaker's cloned voice may be audio samples that sound like the target speaker speaking the text in the text corpus. Voice cloning has advanced such that audio samples of a target speaker's cloned voice may be indistinguishable (to a human and/or to a neural network) from audio samples of the target speaker's actual voice. Further description of voice cloning neural networks may be found, for example in Walczyna, Tomasz, and Zbigniew Piotrowski, “Overview of Voice Conversion Methods Based on Deep Learning,” Applied Sciences 13.5 (2023): 3100.

At step 206, the one or more servers generate, using the one or more samples of the target speaker's cloned voice, one or more personalized parameters for the speech enhancement neural network. As described above, in some embodiments, the speech enhancement neural network may be trained to perform denoising of audio. In some embodiments, generating the one or more personalized parameters for the speech enhancement neural network may include training the speech enhancement neural network, and the one or more personalized parameters may include neural network weights personalized for the target speaker's voice. In some embodiments, training the speech enhancement network may include adding noise and/or other simulated or recorded real world voice data to the one or more samples of the target speaker's cloned voice. The one or more samples of the target speaker's cloned voice with the added noise may be the training input data and the one or more samples of the target speaker's cloned voice without the added noise may be the training output data. Using the training data, the speech enhancement neural network may learn how to take noisy audio as an input and output a denoised version of the noisy audio. The training process may include converging on neural network weights for the speech enhancement neural network that optimally enable the neural network to perform this denoising. It should be appreciated that when the speech enhancement neural network is trained using training data that includes (in some cases, among other samples) one or more samples of the target speaker's cloned voice, the neural network weights for the speech enhancement neural network may be considered personalized for the target speaker's voice. The speech enhancement neural network may be able to better perform speech enhancement of the target speaker's voice due to this personalized training. When this description refers to training a speech enhancement neural network, this should be understood to mean either training the speech enhancement neural network from scratch using the one or more samples of the target speaker's cloned voice, or retraining (which may also be referred to as fine-tuning) an already-trained neural network using the one or more samples of the target speaker's cloned voice in order to personalize it. In some embodiments, retraining a pre-trained neural network may help to reduce training time and computational requirements. In embodiments in which the one or more servers are configured to train a speech enhancement neural network, the speech enhancement neural network may be stored on the one or more servers (e.g., the speech enhancement neural network may be one of the one or more servers 110). In some embodiments, the neural network weights for the speech enhancement neural network may be generated, stored for a short amount of time on the one or more servers before being transmitted to the processing device (e.g., at step 208), and then removed from the one or more servers. Furthermore, the neural network weights for the speech enhancement neural network may not necessarily be stored on the one or more servers when the process 200 begins.

In some embodiments, the personalized parameters for the speech enhancement neural network may include an embedding of the target speaker's voice. The one or more servers may be configured to generate the embedding using the one or more samples of the target speaker's cloned voice. The embedding may be input, by the ear-worn device, to the speech enhancement neural network during inference. The embedding that is input to the neural network may enhance the listening experience for the ear-worn device wearer by identifying speech from the target speaker and processing the identified speech from the target speaker in a preferential manner. Training a neural network can require significant computational resources, and generating an embedding (which may also be referred to as a parameterization), for use as an input to a speech enhancement neural neural network may be simpler and less-processing intensive than training the speech enhancement neural network. Moreover, it may be faster in at least some embodiments. In some embodiments, the embedding may be generated using a speaker embedding neural network that has received on the one or more samples of the target speaker's cloned voice. In some embodiments, the speaker embedding neural network may be trained with a contrastive learning method. During training, two audio clips from the training data may be inputted to the speaker embedding neural network, and the neural network may output two different outputs, one for each audio clip. The losses used during the training may be designed such that, when the two inputted audio clips include speech from the same speaker (i.e., the two audio clips are labeled with the same speaker identifier), the two outputs are pushed to be the same, and when the two inputted audio clips include speech from different speakers, the two outputs are pushed to be different. After many repetitions, the speaker embedding neural network may learn how to generate outputs for audio clips (e.g., extract voice signatures from the audio clips), such that the same embedding results from audio clips from the same speaker, and different embeddings result from audio clips from different speakers. Thus, at step 408, the speaker embedding neural network may receive one or more samples of the target speaker's cloned voice and generate an embedding based on the one or more samples. As described above, the one or more samples of the target speaker's cloned voice may have a higher quality (e.g., lower level of background noise and/or higher SNR) than the one or more recordings of the target speaker's voice, and may thereby provide a more accurate embedding. The speaker embedding neural network may be stored on the one or more servers (e.g., the speaker embedding neural network may be one of the one or more servers 110). The embedding may represent the voice signature of the target speaker speaker (e.g., a speaker with whom the wearer of the ear-worn device frequently interacts) in at least some embodiments, and the embedding may take any suitable form. It should be appreciated that when an embedding generated from one or more samples of the target speaker's cloned voice is inputted to a speech enhancement neural network, the speech enhancement neural network may be considered personalized for the target speaker's voice. Further description of embeddings may be found in U.S. Pat. No. 11,818,523, titled “System and method for enhancing speech of target speaker from audio signal in an ear-worn device using voice signatures,” and issued on Nov. 14, 2023, which is incorporated by reference herein in its entirety. Further description of speech enhancement neural networks may be found in U.S. Pat. No. 11,812,225, titled METHOD, APPARATUS AND SYSTEM FOR NEURAL NETWORK HEARING AID, and issued on Nov. 7, 2023, which is incorporated by reference herein in its entirety.

At step 208, the one or more servers transmit the personalized parameters for the speech enhancement neural network to the processing device. In some embodiments, the transmitted personalized parameters may include neural network weights for the speech enhancement neural network that are personalized for the target speaker's voice (e.g., through training). In some embodiments, the transmitted personalized parameters may include an embedding of the target speaker's voice for inputting to the speech enhancement neural network. The neural network weights and/or the embedding may be the one or more personalized parameters for the speech enhancement neural network that are received by the processing device at step 308 of the process 300 below. As referred to herein, parameters for a neural network may include the weights for the neural network or parameters that are input to the neural network during inference.

Generally, a system (e.g., the system 100) may be configured to perform the process 200, and various elements of the system may be performed the steps of the process 200. In some embodiments, the processing device may be configured to perform one or both of the generating steps 204 and 206. In such embodiments, step 202 may be absent, as the processing device may have captured the one or more recordings and might not need to receive them from another device. In embodiments in which the processing device performs step 204, the processing device may be configured to store and run the voice cloning neural network. In embodiments in which the processing device trains the speech enhancement neural network at step 206, the processing device may be configured to store the speech enhancement neural network. In embodiments in which the processing device generates an embedding at step 206, the processing device may be configured to store a speaker embedding neural network. In embodiments in which the processing device performs step 206, step 208 may be absent.

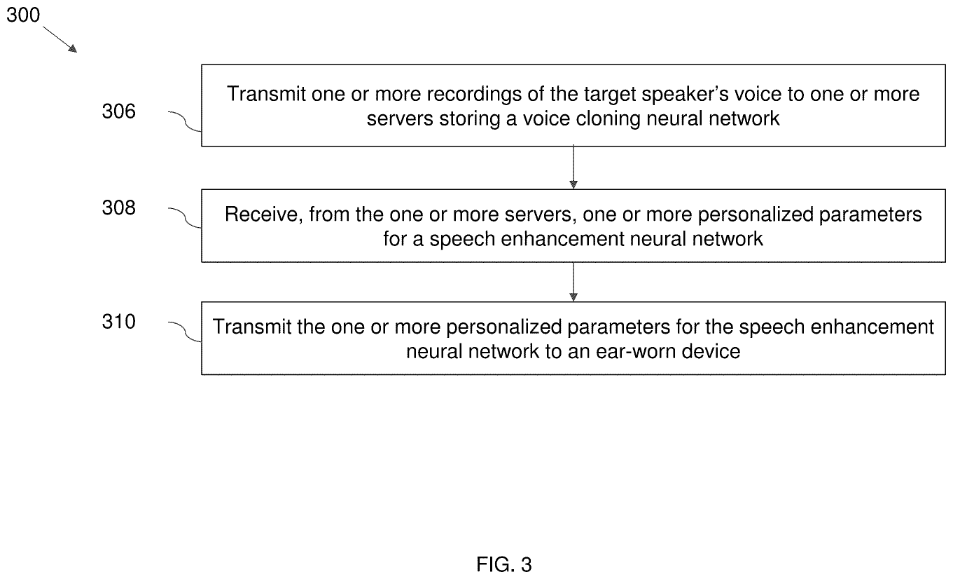

FIG. 3 illustrates a process 300 for personalizing a speech enhancement neural network for a target speaker's voice, in accordance with certain embodiments described herein. The process 300 is performed by a processing device, such as a personal processing device (e.g., a smartphone, tablet, or computer) in communication with an ear-worn device (e.g., a hearing aid, cochlear implant, or earphone). The processing device may be the processing device 102. The ear-worn device may be the ear-worn device 106. The processing device may be considered in communication with the ear-worn device even if the processing device is not in communication with the ear-worn device for the entirety of the process 300.

Further description of how one or more recordings of a target speaker's voice may be obtained may be found above. At step 306, the processing device transmits the one or more recordings of the target speaker's voice to one or more servers (e.g., the one or more servers 104) storing a voice cloning neural network (e.g., one of the neural networks 110). The one or more servers may also be considered the “cloud.” The processing device may be configured to transmit the one or more recordings over a wireless connection (e.g., the wireless connection 108). Storing a neural network may include storing neural network weights. As referred to herein, storing a neural network may include storing weights for the neural network for any amount of time at any time. For example, the neural network weights for the voice cloning neural network may be stored indefinitely, and may be stored on the one or more servers when step 306 occurs. In some embodiments, the processing device may be configured to transmit just one recording of the target speaker's voice to the one or more servers. In some embodiments, the length of the recording may be equal to 10 seconds, equal to 2 minutes, or between 10 seconds and 2 minutes. In some embodiments, the processing device may be configured to transmit more than one recording of the target speaker's voice to the one or more servers. The one or more recordings transmitted at step 306 may be the ones received at step 202 of the process 200.

At step 308, the processing device receives, from the one or more servers, one or more personalized parameters for a speech enhancement network. In some embodiments, the one or more personalized parameters may be neural network weights personalized for the target speaker's voice. In some embodiments, the personalized parameters may be an embedding personalized for the target speaker's voice. Further description may be found with reference to the process 200. The one or more personalized parameters received at step 308 may be the ones transmitted at step 208 of the process 200.

At step 310, the processing device transmits the one or more personalized parameters for the speech enhancement network to an ear-worn device (e.g., the ear-worn device 106). The ear-worn device may be configured to run the speech enhancement neural network. The processing device may be configured to transmit the one or more personalized parameters over a wireless connection (e.g., the wireless connection 112). When the one or more personalized parameters include neural network weights that are personalized for the target speaker's voice, the ear-worn device may be configured to run the speech enhancement neural network in real-time on incoming audio using the neural network weights. When the one or more personalized parameters include an embedding, the ear-worn device may be configured to input the embedding to the speech enhancement neural network running in real-time on incoming audio.

In some embodiments, one processing device may transmit the one or more recordings to the one or more servers, and another processing device may receive the one or more personalized parameters and transmit them to the ear-worn device. For example, the processing device 102 may receive and transmit the one or more personalized parameters, and a second processing device (e.g., belonging to the target speaker) may transmit the one or more recordings. Thus, in some embodiments, the processing device 102 may only perform steps 308 and 310 of the process 300, and another processing device may perform step 306. In some embodiments, the processing device may generate the personalized parameters itself, and thus step 306 may be absent and step 308 may instead include generating the personalized parameters.

In some embodiments, the speech enhancement neural network may be personalized for multiple target speakers' voices. For example, the multiple target speakers may be multiple family members, multiple friends, multiple colleagues of the wearer of the ear-worn device, or a combination thereof. Thus, it should be appreciated that the processes 300 and 200 are not limited to a single target speaker. In some embodiments, one or more recordings for each of the multiple target speakers' voices may be obtained. At step 202, the one or more servers may receive one or more recordings for each of the multiple target speakers' voices. At step 204, the one or more servers may generate one or more samples of each of the multiple target speakers' cloned voices. At step 206, the one or more servers may generate one or more personalized parameters for the speech enhancement neural network for the multiple target speakers' voices using the one or more samples of each of the multiple target speakers' cloned voices. At step 208, the one or more servers may transmit the one or more personalized parameters for the multiple target speakers' voices for the speech enhancement neural network to the processing device. At step 306, the processing device may transmit the one or more recordings for each of the multiple target speakers' voices to the one or servers. At step 308, the processing device may receive one or more personalized parameters for the speech enhancement neural network for the multiple target speakers' voices. At step 310, the processing device may transmit the one or more personalized parameters for the speech enhancement neural network for the multiple target speakers' voices to the ear-worn device. Thus, one or more personalized parameters for a target speaker's voice may be understood to include that the one or more personalized parameters are personalized for that target speaker's voice in addition to other target speakers' voices.

Additionally or alternatively, the speech enhancement neural network may be personalized for one or more target speaker's voices at one time, and that version of the speech enhancement neural network may be used by the ear-worn device. At a later time, more recordings of those target speakers' voices and/or recordings from other target speakers may be captured, more samples of the target speakers' cloned voices may be generated, and those samples may be used to personalize the speech enhancement neural network again. That new version of the speech enhancement may then be used by the ear-worn device. In other words, the process 300 and 200 may be iterated through multiple times, with the one or more personalized parameters being optimized and refined from the previous iteration using new cloned voice samples.

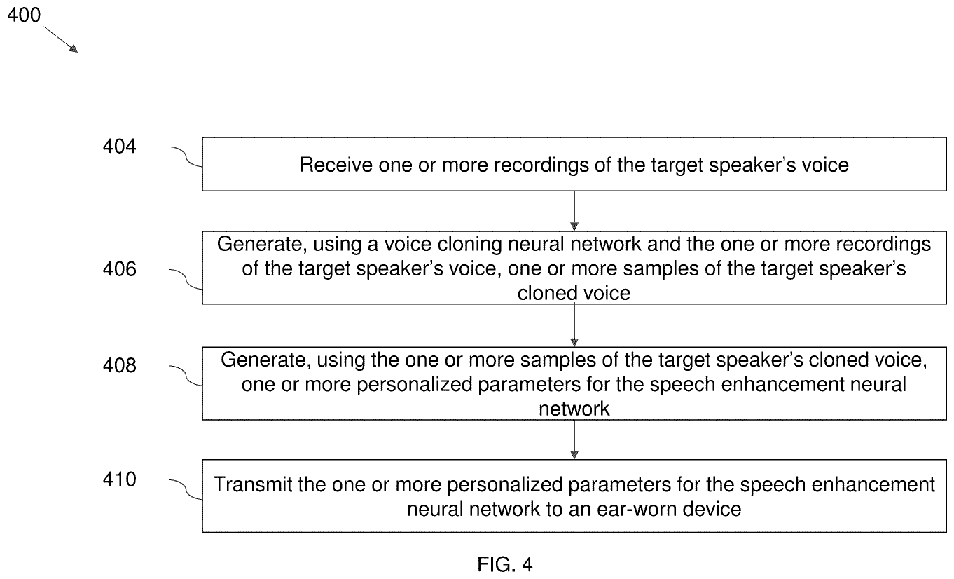

FIG. 4 illustrates a process 400 for training a speech enhancement neural network personalized for a target speaker's voice, in accordance with certain embodiments described herein. The process 400 is a combination of certain steps of the process 300 and the process 200. The process 400 may be performed by a system (e.g., the system 100), which may include a processing device (e.g., a smartphone, tablet, or computer), one or more servers (which may be considered the “cloud”), and an ear-worn device (e.g., a hearing aid, cochlear implant, or earphone). The processing device may be the processing device 102. The one or more servers may be the one or more servers 104. The ear-worn device may be the ear-worn device 106. The one or more servers may store a voice cloning neural network (e.g., one of the one or more neural networks 110. Storing a neural network may include storing neural network weights. As referred to herein, storing a neural network may include storing weights for the neural network for any amount of time at any time. For example, the neural network weights for the voice cloning neural network may be stored indefinitely, and may be stored on the one or more servers when the process 400 begins. As another example, in embodiments in which the one or more servers train a speech enhancement neural network, neural network weights for the speech enhancement neural network may be stored for a short amount of time on the one or more servers before being transmitted to the processing device (e.g., at step 208), and then removed from the one or more servers. Furthermore, the neural network weights for the speech enhancement neural network may not necessarily be stored on the one or more servers when the process 400 begins.

At step 404, the system receives one or more recordings of the target speaker's voice. Step 404 may be the same as step 202, and further description may be found with reference to step 202. In some embodiments, step 404 may be performed by the one or more servers. For example, the processing device may capture the recordings and transmit them to the one or more servers. In some embodiments, step 404 may be absent, such as when the processing device performs step 406.

At step 406, the system generates, using a voice cloning neural network and the one or more recordings of the target speaker's voice, one or more samples of the target speaker's cloned voice. Step 406 may be the same as step 204, and further description may be found with reference to step 204. In some embodiments, step 406 may be performed by the one or more servers. In some embodiments, step 406 may be performed by the processing device.

At step 408, the system generates, using the one or more samples of the target speaker's cloned voice, one or more personalized parameters for the speech enhancement neural network. Step 408 may be the same as step 206, and further description may be found with reference to step 206. In some embodiments, step 408 may be performed by the one or more servers. In some embodiments, step 408 may be performed by the processing device.

At step 410, the system transmits the one or more personalized parameters for the speech enhancement neural network to an ear-worn device. Step 410 may be the same as step 310, and further description may be found with reference to step 310. In some embodiments, step 410 may be performed by the processing device. Between step 408 and step 410, the one or more servers may transmit the one or more personalized parameters to the processing device (as described with reference to step 208), and the processing device may receive the one or more personalized parameters from the one or more servers (as described with reference to step 308).

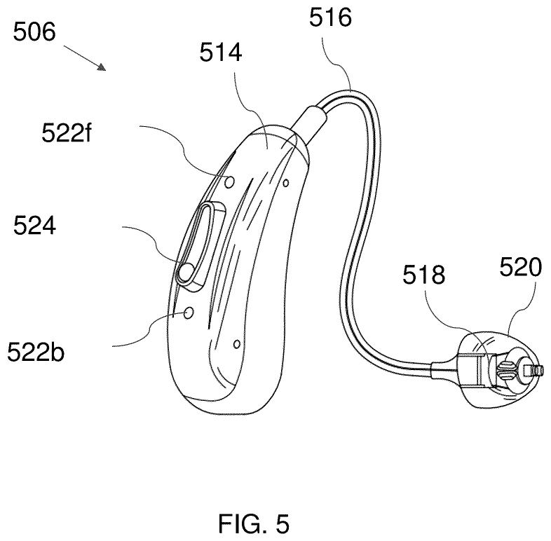

FIG. 5 illustrates a hearing aid 506, in accordance with certain embodiments described herein. The hearing aid 506 may be an example of the ear-worn device 106. The hearing aid 506 is a receiver-in-canal (RIC) (also referred to as a receiver-in-the-ear (RITE)) type of hearing aid. However, any other type of hearing aid (e.g., behind-the-ear, in-the-ear, in-the-canal, completely-in-canal, open fit, etc.) may also be used. The hearing aid 506 includes a body 514, a receiver wire 516, a receiver 518, and a dome 520. The body 514 is coupled to the receiver wire 516 and the receiver wire 516 is coupled to the receiver 518. The dome 520 is placed over the receiver 518. The body 514 includes a front microphone 522f, a back microphone 522b, and a user input device 524. (The front microphone 522f and the back microphone 522b may correspond to the one or more microphones 622). The body 514 additionally includes circuitry (e.g., any of the circuitry described above, aside from the receiver 518) not illustrated in FIG. 5. When the hearing aid 506 is worn, the front microphone 522f may be closer to the front of the wearer and the back microphone 522b may be closer to the back of the wearer. The front microphone 522f and the back microphone 522b may be configured to receive sound signals and generate audio signals based on the sound signals. The user input device 524 may be configured to control certain functions of the hearing aid 506, such as switching modes. The receiver wire 516 may be configured to transmit audio signals from the body 514 to the receiver 518. The receiver 518 may be configured to receive audio signals (i.e., those audio signals generated by the body 514 and transmitted by the receiver wire 516) and generate sound signals based on the audio signals. The dome 520 may be configured to fit tightly inside the wearer's ear and direct the sound signal produced by the receiver 518 into the ear canal of the wearer.

In some embodiments, the length of the body 514 may be equal to 2 cm, equal to 5 cm, or between 2 and 5 cm in length. In some embodiments, the weight of the hearing aid 506 may be less than 4.5 grams. In some embodiments, the spacing between the microphones may be equal to 5 mm, equal to 12 mm, or between 5 and 12 mm. In some embodiments, the body 514 may include a battery (not visible in FIG. 5), such as a lithium ion rechargeable coin cell battery.

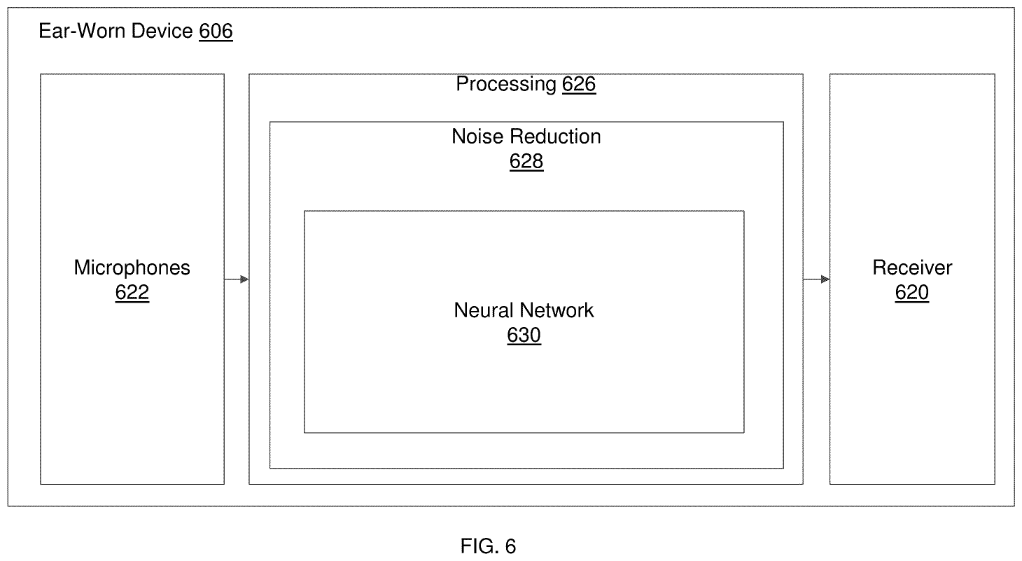

FIG. 6 illustrates an ear-worn device 606, in accordance with certain embodiments described herein. The ear-worn device 606 may be, for example, a hearing aid, a cochlear implant, or an earphone. For example, the ear-worn device 606 may correspond to the ear-worn device 106 and/or the hearing aid 506. The ear-worn device 606 includes microphones 622, processing circuitry 626, and a receiver 620. The processing circuitry 626 includes noise reduction circuitry 628. The noise reduction circuitry 628 includes neural network circuitry 630. The neural network circuitry 630 may be configured to implement a neural network (or, more generally, one or more neural network layers). For example, the neural network may be any of the speech enhancement neural networks described herein, and the ear-worn device 606 may thereby run a speech enhancement neural network.

The one or more microphones 622 (which may correspond to the microphones 522) may include one, two, or more than two (e.g., 3, 4, or more) microphones. For example, the one or more microphones 622 may include two microphones, a front microphone that is closer to the front of the wearer of the ear-worn device 606 and a back microphone that is closer to the back of the wearer of the ear-worn device 606. As another example, the one or more microphones 622 may include more than two microphones in an array. Microphones in an array may be linked via wireless communication (e.g., the microphones may be disposed on two different ear-worn devices configured for binaural communication). The one or more microphones 622 may be configured to receive sound signals and to generate audio signals from the sound signals.

The processing circuitry 626 may be configured to process the audio signals from the microphones 622. The processing circuitry 626 may be configured to perform some or all of input calibration, anti-feedback processing, wind reduction, short-time Fourier transformation (STFT), wide dynamic range compression (WDRC), inverse STFT, and output calibration. The processing circuitry 626 may be additionally configured to perform noise reduction using the noise reduction circuitry 628.

The receiver 620 (which may correspond to the receiver 520) may be configured to play back the output of the processing circuitry 626 as sound into the ear of the user.

It should be appreciated that the ear-worn device 606 or any of its components may include more elements than illustrated, and these elements may be coupled upstream, downstream, or between any of the elements illustrated in FIG. 6.

This disclosure includes, at least, the following examples.

Example 1 is directed to a system for training a speech enhancement neural network personalized for a target speaker's voice, the system comprising: an ear-worn device configured to run the speech enhancement neural network; a processing device in communication with an ear-worn device; and one or more servers in communication with the processing device; wherein: the one or more servers are configured to: receive one or more recordings of the target speaker's voice; generate, using a voice cloning neural network and the one or more recordings of the target speaker's voice, one or more samples of the target speaker's cloned voice; and generate, using the one or more samples of the target speaker's cloned voice, one or more personalized parameters for the speech enhancement neural network; and the processing device is configured to: transmit the one or more personalized parameters for the speech enhancement neural network to the ear-worn device.

Example 2 is directed to the system of example 1, wherein the processing device is a first processing device, and wherein the one or more servers are configured, when receiving the one or more recordings of the target speaker's voice, to receive the one or more recordings of the target speaker's voice from the first processing device or a second processing device.

Example 3 is directed to the system of example 2, wherein the first processing device or the second processing device is further configured to provide an instruction to capture or select the one or more recordings of the target speaker's voice.

Example 4 is directed to the system of example 3, wherein the first processing device or the second processing device is configured, when providing the instruction to capture or select the one or more recordings of the target speaker's voice, to provide the instruction as text displayed on a display screen.

Example 5 is directed to the system of any of examples 3-4, wherein the first processing device or the second processing device is configured, when providing the instruction to capture or select the one or more recordings of the target speaker's voice, to provide an instruction to capture a recording of a certain minimum length of time.

Example 6 is directed to the system of example 5, wherein the minimum length of time is equal to 10 seconds, equal to 2 minutes, or between 10 seconds and 2 minutes.

Example 7 is directed to the system of any of examples 3-6, wherein the first processing device or the second processing device is further configured to receive an email or text with a link, and to provide the instruction in response to a user selection of the link.

Example 8 is directed to the system of any of examples 2-7, wherein the first processing device or the second processing device is further configured to provide an instruction to upload an already-saved video or audio file that includes the target speaker's voice.

Example 9 is directed to the system of any of examples 1-8, wherein the one or more servers are configured, when receiving the one or more recordings of the target speaker's voice, to receive only one recording of the target speaker's voice.

Example 10 is directed to the system of any of examples 1-9, wherein the ear-worn device comprises a hearing aid, a cochlear implant, or an earphone.

Example 11 is directed to the system of any of examples 1-10, wherein the one or more servers are configured to generate the one or more personalized parameters for the speech enhancement neural network by training the speech enhancement neural network.

Example 12 is directed to the system of example 11, wherein the one or more servers are configured, when training the speech enhancement neural network, to retrain the speech enhancement neural network.

Example 13 is directed to the system of example 11, wherein the one or more personalized parameters comprise neural network weights of the speech enhancement neural network.

Example 14 is directed to the system of any of examples 1-13, wherein the one or more personalized parameters comprise an embedding of the target speaker's voice.

Example 15 is directed to the system of example 14, wherein the one or more servers are configured to generate the embedding of the target speaker's voice by running a speaker embedding neural network on the one or more samples of the target speaker's cloned voice.

Example 16 is directed to the system of any of examples 1-15, wherein the one or more samples of the target speaker's cloned voice have a higher quality than the one or more recordings of the target speaker's voice.

Example 17 is directed to the system of any of examples 1-16, wherein the processing device is a first processing device, and wherein the first processing device or a second processing device is configured to capture the one or more recordings of the target speaker's voice using a microphone or microphones of the first processing device or the second processing device.

Example 18 is directed to the system of any of examples 1-17, wherein the system is further configured to capture the one or more recordings of the target speaker's voice automatically.

Example 19 is directed to the system of any of examples 1-18, wherein the one or more recordings are received synchronously.

Example 20 is directed to the system of any of examples 1-18, wherein the one or more recordings are received asynchronously.

Example 21 is directed to t method for training a speech enhancement neural network personalized for a target speaker's voice, the method comprising: receiving one or more recordings of the target speaker's voice; generating, using a voice cloning neural network and the one or more recordings of the target speaker's voice, one or more samples of the target speaker's cloned voice; generating, using the one or more samples of the target speaker's cloned voice, one or more personalized parameters for the speech enhancement neural network; and transmitting the one or more personalized parameters for the speech enhancement neural network to an ear-worn device.

Example 22 is directed to the method of example 21, wherein receiving the one or more recordings of the target speaker's voice comprises receiving the one or more recordings of the target speaker's voice from a first processing device in communication with the ear-worn device or from a second processing device.

Example 23 is directed to the method of example 22, further comprising providing an instruction to capture or select the one or more recordings of the target speaker's voice.

Example 24 is directed to the method of example 23, wherein providing the instruction to capture or select the one or more recordings of the target speaker's voice comprises providing the instruction as text displayed on a display screen.

Example 25 is directed to the method of any of examples 23-24, wherein providing the instruction to capture or select the one or more recordings of the target speaker's voice comprises providing an instruction to capture a recording of a certain minimum length of time.

Example 26 is directed to the method of example 25, wherein the minimum length of time is equal to 10 seconds, equal to 2 minutes, or between 10 seconds and 2 minutes.

Example 27 is directed to the method of any of examples 23-26, further comprising receiving an email or text with a link, and providing the instruction in response to a user selection of the link.

Example 28 is directed to the method of any of examples 22-27, further comprising providing an instruction to upload an already-saved video or audio file that includes the target speaker's voice.

Example 29 is directed to the method of any of examples 21-28, wherein receiving the one or more recordings of the target speaker's voice comprises receiving only one recording of the target speaker's voice.

Example 30 is directed to the method of any of examples 21-29, wherein the ear-worn device comprises a hearing aid, a cochlear implant, or an earphone.

Example 31 is directed to the method of any of examples 21-30, wherein generating the one or more personalized parameters for the speech enhancement neural network comprises training the speech enhancement neural network.

Example 32 is directed to the method of example 31, wherein training the speech enhancement neural network comprises retraining the speech enhancement neural network.

Example 33 is directed to the method of example 31, wherein the one or more personalized parameters comprise neural network weights of the speech enhancement neural network.

Example 34 is directed to the method of any of examples 21-33, wherein the one or more personalized parameters comprise an embedding of the target speaker's voice.

Example 35 is directed to the method of example 24, further comprising generating the embedding of the target speaker's voice by running a speaker embedding neural network on the one or more samples of the target speaker's cloned voice.

Example 36 is directed to the method of any of examples 21-35, wherein the one or more samples of the target speaker's cloned voice have a higher quality than the one or more recordings of the target speaker's voice.

Example 37 is directed to the method of any of examples 21-36, further comprising capturing the one or more recordings of the target speaker's voice using a microphone or microphones of a first processing device in communication with the ear-worn device or with a second processing device.

Example 38 is directed to the method of any of examples 21-37, further comprising capturing the one or more recordings of the target speaker's voice automatically.

Example 39 is directed to the method of any of examples 21-38, wherein the one or more recordings are received synchronously.

Example 40 is directed to the method of any of examples 21-38, wherein the one or more recordings are received asynchronously.

Example 41 is directed to a processing device in communication with an ear-worn device, the processing device configured to: transmit one or more recordings of a target speaker's voice to one or more servers storing a voice cloning neural network; receive, from the one or more servers, one or more personalized parameters for a speech enhancement neural network; and transmit the one or more personalized parameters for the speech enhancement neural network to an ear-worn device.

Example 42 is directed to the processing device of example 41, wherein the processing device is further configured to provide an instruction to capture or select the one or more recordings of the target speaker's voice.

Example 43 is directed to the processing device of example 42, wherein the processing device is configured, when providing the instruction to capture or select the one or more recordings of the target speaker's voice, to provide the instruction as text displayed on a display screen.

Example 44 is directed to the processing device of any of examples 42-43, wherein the processing device is configured, when providing the instruction to capture or select the one or more recordings of the target speaker's voice, to provide an instruction to capture a recording of a certain minimum length of time.

Example 45 is directed to the processing device of example 44, wherein the minimum length of time is equal to 10 seconds, equal to 2 minutes, or between 10 seconds and 2 minutes.

Example 46 is directed to the processing device of any of examples 42-45, wherein the processing device is further configured to receive an email or text with a link, and to provide the instruction in response to a user selection of the link.

Example 47 is directed to the processing device of any of examples 42-46, wherein the processing device is further configured to provide an instruction to upload an already-saved video or audio file that includes the target speaker's voice.

Example 48 is directed to the processing device of any of examples 41-47, wherein the one or more recordings of the target speaker's voice comprise only one recording of the target speaker's voice

Example 49 is directed to the processing device of any of examples 41-48, wherein the ear-worn device comprises a hearing aid, a cochlear implant, or an earphone.

Example 50 is directed to the processing device of any of examples 41-49, wherein the one or more personalized parameters comprise neural network weights of the speech enhancement neural network.

Example 51 is directed to the processing device of any of examples 41-50, wherein the one or more personalized parameters comprise an embedding of the target speaker's voice.

Example 52 is directed to the processing device of any of examples 41-51, wherein the processing device is further configured to capture the one or more recordings of the target speaker's voice using a microphone or microphones of the processing device.

Example 53 is directed to the processing device of any of examples 41-52, wherein the processing device is further configured to capture the one or more recordings of the target speaker's voice automatically.

Example 54 is directed to a method comprising: transmitting one or more recordings of a target speaker's voice to one or more servers storing a voice cloning neural network; receiving, from the one or more servers, one or more personalized parameters for a speech enhancement neural network; and transmitting the one or more personalized parameters for the speech enhancement neural network to an ear-worn device.

Example 55 is directed to the method of example 54, further comprising providing an instruction to capture or select the one or more recordings of the target speaker's voice.

Example 56 is directed to the method of example 55, wherein providing the instruction to capture or select the one or more recordings of the target speaker's voice comprises providing the instruction as text displayed on a display screen.

Example 57 is directed to the method of any of examples 55-56, wherein providing the instruction to capture or select the one or more recordings of the target speaker's voice comprises providing an instruction to capture a recording of a certain minimum length of time.

Example 58 is directed to the method of example 57, wherein the minimum length of time is equal to 10 seconds, equal to 2 minutes, or between 10 seconds and 2 minutes.

Example 59 is directed to the method of any of examples 55-58, further comprising receiving an email or text with a link, and providing the instruction in response to a user selection of the link.

Example 60 is directed to the method of any of examples 55-59, further comprising providing an instruction to upload an already-saved video or audio file that includes the target speaker's voice.

Example 61 is directed to the method of any of examples 54-60, wherein the one or more recordings of the target speaker's voice comprise only one recording of the target speaker's voice

Example 62 is directed to the method of any of examples 54-61, wherein the ear-worn device comprises a hearing aid, a cochlear implant, or an earphone.

Example 63 is directed to the method of any of examples 54-62, wherein the one or more personalized parameters comprise neural network weights of the speech enhancement neural network.

Example 64 is directed to the method of any of examples 54-63, wherein the one or more personalized parameters comprise an embedding of the target speaker's voice.

Example 65 is directed to the method of any of examples 54-64, further comprising capturing the one or more recordings of the target speaker's voice automatically.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. A system for training a speech enhancement neural network personalized for a target speaker's voice, the system comprising:
an ear-worn device configured to run the speech enhancement neural network;
a processing device in communication with an ear-worn device; and
one or more servers in communication with the processing device; wherein:
the one or more servers are configured to:
receive one or more recordings of the target speaker's voice;
generate, using a voice cloning neural network and the one or more recordings of the target speaker's voice, one or more samples of the target speaker's cloned voice; and
generate, using the one or more samples of the target speaker's cloned voice, one or more personalized parameters for the speech enhancement neural network; and
the processing device is configured to:
transmit the one or more personalized parameters for the speech enhancement neural network to the ear-worn device.

2. The system of claim 1, wherein the processing device is a first processing device, and wherein the one or more servers are configured, when receiving the one or more recordings of the target speaker's voice, to receive the one or more recordings of the target speaker's voice from the first processing device or a second processing device.

3. The system of claim 2, wherein the first processing device or the second processing device is further configured to provide an instruction to capture or select the one or more recordings of the target speaker's voice.

4. The system of claim 3, wherein the first processing device or the second processing device is configured, when providing the instruction to capture or select the one or more recordings of the target speaker's voice, to provide the instruction as text displayed on a display screen.

5. The system of claim 3, wherein the first processing device or the second processing device is configured, when providing the instruction to capture or select the one or more recordings of the target speaker's voice, to provide an instruction to capture a recording of a certain minimum length of time.

6. The system of claim 5, wherein the minimum length of time is equal to 10 seconds, equal to 2 minutes, or between 10 seconds and 2 minutes.

7. The system of claim 3, wherein the first processing device or the second processing device is further configured to receive an email or text with a link, and to provide the instruction in response to a user selection of the link.

8. The system of claim 2, wherein the first processing device or the second processing device is further configured to provide an instruction to upload an already-saved video or audio file that includes the target speaker's voice.

9. The system of claim 1, wherein the one or more servers are configured, when receiving the one or more recordings of the target speaker's voice, to receive only one recording of the target speaker's voice.

10. The system of claim 1, wherein the ear-worn device comprises a hearing aid, a cochlear implant, or an earphone.

11. The system of claim 1, wherein the one or more servers are configured to generate the one or more personalized parameters for the speech enhancement neural network by training the speech enhancement neural network.

12. The system of claim 11, wherein the one or more servers are configured, when training the speech enhancement neural network, to retrain the speech enhancement neural network.

13. The system of claim 11, wherein the one or more personalized parameters comprise neural network weights of the speech enhancement neural network.

14. The system of claim 1, wherein the one or more personalized parameters comprise an embedding of the target speaker's voice.

15. The system of claim 14, wherein the one or more servers are configured to generate the embedding of the target speaker's voice by running a speaker embedding neural network on the one or more samples of the target speaker's cloned voice.

16. The system of claim 1, wherein the one or more samples of the target speaker's cloned voice have a higher quality than the one or more recordings of the target speaker's voice.

17. The system of claim 1, wherein the processing device is a first processing device, and wherein the first processing device or a second processing device is configured to capture the one or more recordings of the target speaker's voice using a microphone or microphones of the first processing device or the second processing device.

18. The system of claim 1, wherein the system is further configured to capture the one or more recordings of the target speaker's voice automatically.

19. The system of claim 1, wherein the one or more recordings are received synchronously.

20. The system of claim 1, wherein the one or more recordings are received asynchronously.
